(19) United States
(12) Patent Application Publication
(10) Pub. No.: US 2013/0266243 A1
(43) Pub. Date: Oct. 10, 2013

(54) Flexible Package with Internal, Resealable Closure Feature

(71) Applicants: Panagiotis Kinigakis, Roscoe, IL (US); Kenneth C. Pokusa, Indian Head Park, IL (US)

(72) Inventors: Panagiotis Kinigakis, Roscoe, IL (US); Kenneth C. Pokusa, Indian Head Park, IL (US)

(21) Appl. No.: 13/799,187

(22) Filed: Mar. 13, 2013

Related U.S. Application Data
(63) Continuation of application No. 11/267,174, filed on Nov. 7, 2005, now Pat. No. 8,398,306.

(51) Int. Cl. B65D 33/16; B31B 1/90; B65D 33/20; B65D 33/08

(52) U.S. Cl. CPC B65D 33/16; B65D 33/08; B31B 1/90; B65D 33/20
USPC 383/9; 493/212; 493/213; 493/220; 383/210.1

(57) ABSTRACT

A reclosable flexible package having a reclosable closure comprising easy-to-use adhesive securement means in combination with non-reclosable closures provided above and below the reclosable closure. The package provides a re-openable seal for reclosing the bag upon a partial discharge of the contents thereof, such as food contents. The flexible package offers manufacturing ease and cost-savings, and tamper-resistance. The flexible package also may be incorporated into a bag-in-box package configuration. Methods of making and filling the package also are provided.

### CROSS-REFERENCE TO RELATED APPLICATION

This application is a continuation of U.S. patent application Ser. No. 11/267,174, filed Nov. 7, 2005, which is hereby incorporated herein by reference in its entirety.

### FIELD OF THE INVENTION

This invention relates to flexible packages, such as plastic bags, and in particular to package closures employing adhesives.

Certain packages for food products comprised of particulates, such as shredded cheese, cereal, trail mix, nuts, dried fruit, small cookies, crackers, chocolate, confections, for example, comprise a pouch which is open at one end, or along one side, so as to allow product to be poured or shaken through a reclosable opening.

One widely used means of providing package reclosability is to employ zippers compatible with flexible packages of plastic film construction. One problem with such zippers is that application of zippers to a film roll makes the film roll bulky and more difficult to handle. Although packaging zippers can be applied in high speed in-line form-fill-seal operations, the equipment requirements for application of zippers and the expense of the zipper materials can be significant. In addition, zippers may not provide hermetic seals when desired. Also, some consumers have difficulty operating and manipulating zipper closures.

Improvements are desired in packaging closures which are simple and economical yet reliable, durable, and tamper-resistant.

### SUMMARY

The invention provides a reclosable flexible package having a reclosable closure comprising easy-to-use adhesive securement means in combination with non-reclosable closures provided above and below the reclosable closure.

In one embodiment, a reclosable flexible package has opposed front and rear panels joined together to define a cavity enclosed by opposite side portions and a bottom portion of the package. An openable or removable non-reclosable closure, located at an upper end portion opposite the bottom portion and extending between opposite side portions of the package, is adapted to define a package mouth when opened or removed. An openable reclosable closure extending between the opposite side portions of the package at a location below the sealed portion, is adapted to be manually pulled open and reclosed for selectively opening and closing the mouth after the sealed portion has been opened. Another openable non-reclosable closure extends between the opposite side portions of the package at a location below the reclosable closure.

In one particular embodiment, the reclosable closure comprises a reclosable coating provided on at least one of the interior faces of the front and rear panels of the package. Whether applied to one or both interior faces of the front and rear panels, the reclosable coating is adapted to releasably attach the interior faces of front and rear panels of the package. The “reclosable coating” refers to a thin layer of material applied onto the film substrate that is solid at room temperature, has a surface energy substantially similar to the sealant side of the film substrate, and produces mutually bondable surfaces. In one embodiment, the reclosable closure comprises substantially continuous bands of reclosable coating oppositely aligned on interior opposing faces of the front and rear panels, wherein the bands are adapted to be manually pressed into mutual adhering contact and manually pulled apart more than once. In one embodiment, the reclosable coating has balanced tack such that it has sufficient tack to allow multiple unsealings and resealings of the package walls at the closure site, but also it is not overly tacky so that it has low-pick up of food contents of the package sufficient to reduce incidence and rate of contamination-deadening of the reclosable closure from food dispensing. In one embodiment, the reclosable coating is selected from the group consisting of ethylene vinyl acetate copolymers, water-based acrylics, curable acrylics, and styrenic block copolymers. The reclosable coating material may be a transparent, translucent or a tinted coating material.

In another particular embodiment, the reclosable closure comprises a self-supporting tape material attached on interior faces of the front and rear panels of the package. The self-supporting tape material may comprise a laminate construction comprising a single-faced adhesive tape substrate, which bears a reclosable coating on the non-tacky side thereof. The tape may be a transparent, translucent or tinted discrete band material.

Food product may be introduced into the package cavity before the closures are sealed, providing a resealable food package. The package may further include visual textual and/or tactile indicia providing user instructions or guidance for applying pressure at the reclosable closure for reclosing the package. The package optionally may further include a rupturable line of weakness between the openable or removable non-reclosable closure at the upper end of the package and the reclosable closure, which is adapted, upon complete rupture, to remove the upper non-reclosable closure and provide a package opening. To facilitate rupture and opening the package mouth, the line of weakness optionally may intersect a notch provided on at least one side edge of the package. The package construction may comprise a folded polymeric sheet providing front and rear wall panels which are joined at opposite side portions thereof and folded at a bottom portion thereof. In another folded configuration, the package is folded at the opposite side portions sufficient to provide flaps extending in a machine direction which are arranged to include an overlap portion which is sealed, or a fin seal, and a bottom portion is sealed in a cross-machine direction. In another embodiment, the flexible package also may be incorporated into a bag-in-box package configuration.

The resealable flexible packages may provide greater manufacturing efficiencies and cost savings as compared to known packages with integral zippers. Also, tamper resistance is provided for the reclosable closure and package contents by provision of manually-openable, non-reclosable hermetic seals at both sides of the reclosable closure. The hermetic seals also better isolate the reclosable closure during manufacture, shipping, storage, handling and display, etc., until purchased and used by a consumer. Methods of forming and filling the reclosable package also are provided. The packages can be used to store a wide variety of foods. They can be used to store snacks, such as trail mix, nuts, dried fruit, small cookies, crackers, chocolate, confections, etc. They also can be used to store, e.g., cheese, meat, cereal, ground coffee, coffee beans, etc.

### BRIEF DESCRIPTION OF THE DRAWINGS

FIG. 1 is a front elevational view of a flexible reclosable package according to an embodiment of the invention.

FIG. 2 is a cross-sectional view taken along line A-A of a partly opened package according to FIG. 1.

FIG. 3 is a front elevational view of a fully opened package according to FIG. 1.

FIG. 4 a cross-sectional view taken along line B-B of the opened package according to FIG. 3.

FIG. 5 is a front elevational view of a flexible reclosable package according to another embodiment of the invention.

FIG. 6 is a cross-sectional view taken along line C-C of the package according to FIG. 5.

FIG. 7 a cross-sectional view taken along line C-C of an opened package according to FIG. 5.

FIG. 8 is a rear elevational view of the package of FIG. 5.

FIG. 9 is a front elevational view of a flexible reclosable package according to another embodiment of the invention.

FIG. 10 is a front elevational view of a flexible reclosable package according to another embodiment of the invention.

FIG. 11 is a front elevational view of a flexible reclosable package according to another embodiment of the invention.

FIG. 12 is a front perspective view of a flexible reclosable stand-up package according to another embodiment of the invention.

FIG. 13 is a front perspective view of a bag-in-box package according to another embodiment of the present invention.

FIG. 14 is a front perspective view of the package of FIG. 13 with an opened box end.

FIG. 15 a cross-sectional view taken along line D-D of a partly opened package according to FIG. 14.

FIG. 16 is a front perspective view of a flexible reclosable Doy-style stand-up pouch according to another embodiment of the invention.

FIG. 17 is a side view of the Doy-style stand-up pouch of FIG. 16.

FIG. 18 is a perspective view of a flexible reclosable stand-up package with a tucked bottom seal according to another embodiment of the invention.

The figures are not necessarily drawn to scale. Similarly numbered elements in different figures represent like features unless indicated otherwise.

### DETAILED DESCRIPTION OF THE PREFERRED EMBODIMENTS

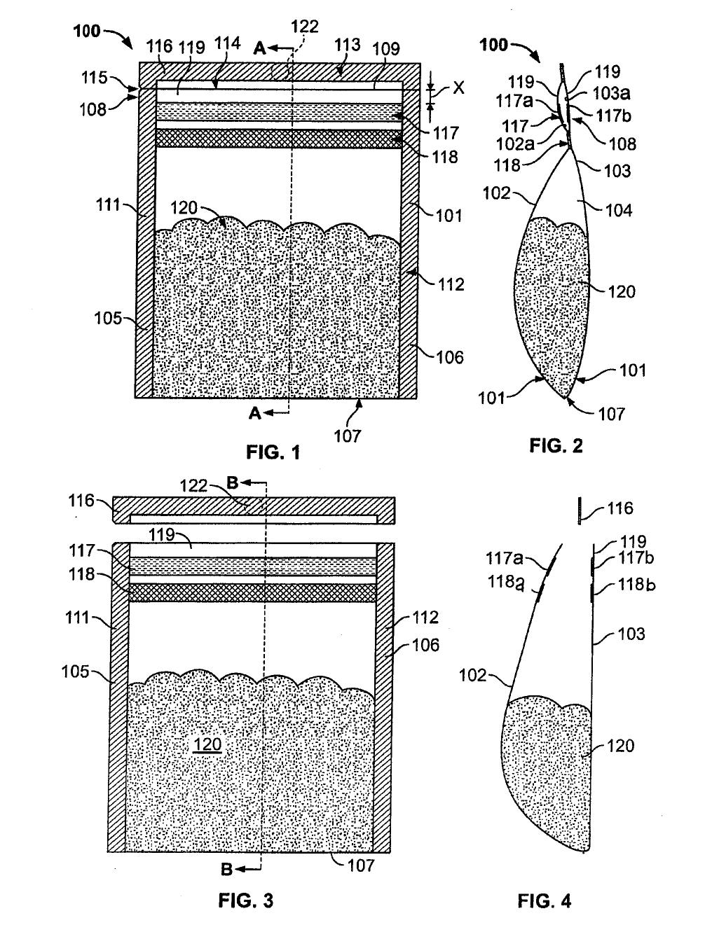

Referring to FIG. 1, a flexible package 100 is generally indicated in accordance with an embodiment of the present invention. FIG. 2 shows partly opened package 100 with reclosable seal 117 shown as opened for sake of illustration only. FIGS. 3 and 4 show package 100 with top closure portion 116 separated and removed from the remainder of the package 100.

In this illustration of FIGS. 1-4, the package 100 is formed from a flexible sheet material 101, which also is referred to herein as a film substrate, which has opposed front and rear panels 102 and 103 joined together to define a cavity 104. Food 120 or other content is contained within cavity 104. The upper end portion 108 of the package communicates with the cavity 104. For purposes of this non-limiting illustration, the flexible sheet material or film substrate 101 is a polymeric sheet. The polymeric sheet 101 has a dead-fold portion 107 formed by folding the sheet back upon itself, and the resulting overlapping opposite side portions 105 and 106 of the sheet 101 are fusion sealed together forming opposite side fusion seals 111 and 112. A fusion seal 113 also is formed at a top closure portion 116 of the package 100, providing a three-sided seal bag construction. A notched line of weakness 109 is provided immediately below and generally parallel to the top fusion seal 113, which in this illustration includes a rupturable line of weakness 114 and associated side tear notch 115. Openable reclosable closure 117 is provided below and generally parallel to fusion seal 113 and the notched line of weakness 109. A non-reclosable peelable seal 118 is provided below and generally parallel to the reclosable closure 117 at a lower location in the upper end 108 of package 100.

In this illustration, reclosable closure 117 comprises resealable adhesive bands 117a and 117b formed on the opposing inner faces 102a and 103a of walls 102 and 103 between line of weakness 114 and seal 118. Resealable adhesive bands 117a and 117b provide the user a gripping portion 119, indicated as having a dimension “X”, which aids a user in manually separating the bag panels 102 and 103 apart at the resealable bands 117a and 117b. Resealable bands 117a and 117b may be applied as coatings, which, at ambient conditions, maintain sufficient integrity not to migrate, sag or flow out of position in any significant manner.

The cross-sectional view of FIG. 2 shows the resealable bands 117a and 117b pulled apart from one another prior to the first opening of the cavity 104 of package 100. The bands 117a and 117b can be provided in an unbonded or bonded configuration in the initially filled package, depending on the ease of manufacturing. The resealable bands 117a and 117b comprise a reclosable coating material suited for sealing and resealing the package 100 multiple times while exposed to ambient conditions over an extended period of time. In a particular embodiment, the reclosable coating material has low-pick tendency relative to the filled contents of the package when the food contents are dispensed from the package.

In one particular embodiment, the resealable bands 117a and 117b are comprised of a reclosable coating material, which may comprise a “cold glue” which does not delaminate from the packaging panels, retains balanced tack properties adequate to allow multiple unsealings and resealings of the package walls at the adhesive site even after the adhesive is exposed to ambient conditions over an extended period of time, and does not become contaminated and deadened (from a tackiness standpoint) from exposure to food detritus. In addition, in another embodiment, the resealable bands may be pre-applied to packaging films stored as wound spools or rolls until unwound during package manufacture, where it is desirable to provide a reclosable coating which is not overly tacky to impede unwinding operations. In a particular embodiment, the reclosable coating is cohesive in respect of being more adhesive to like band materials than substrate films or food detritus. It also may have pressure-sensitive aspects in that it forms an unsealable bond with bands of like material upon application of pressure only, i.e., without requiring the application of heat, moisture, or radiation. Resealable compositions of this general type permit the bond that they form to be readily broken, as desired, so that the package walls may be peeled apart at the location of the seal without significant damage to the substrate to which the resealable pressure-sensitive contact adhesive had been applied.

The strength of the resealable seal 117 is such that it can be readily opened by application of manual outward force to the package by the consumer, but is not susceptible to accidental opening due to normal stresses associated with product containment during storage and handling. For instance, the resealable seal 117 generally may have a peel force ranging from about 100 g/inch to about 700 g/inch, particularly about 100 g/inch to about 300 g/inch, as measured by ASTM D 3330 (peel test). The resealable seal 117 generally may have a tack value not exceeding 5 psi when pre-loaded with 4.5 pounds, and not exceeding 15 psi when pre-loaded with 10 pounds, as measured by ASTM D 2979 (probe tack). It can be resealed by application of firm manual pressure, such as by pressing the seal 117 band or bands from one lateral end towards and to the opposite lateral end thereof to help ensure a continuous seal is restored after the bag has been temporarily opened. In one non-limiting embodiment, the resealable seal 117 is substantially impermeable to air, as well as to liquids which may be present in the pouch. The level of hermeticity needed generally will be determined based on the shelf-stability and/or form and sizing of the food contents or other contents stored in the package. In other embodiments, the resealable seal 117 may comprise intermittent or discontinuous bands, or bands that only part traverse the width of the package at its mouth portion, depending in large part on the type and form of the contents intended to be stored in the package.

In one embodiment, the reclosable closure comprises substantially continuous bands 117a and 117b of reclosable coating material oppositely aligned on interior faces 102a and 103a of the front 102 and rear panels 103. The bands 117a and 117b are adapted to be manually pressed into mutual adhering contact and manually pulled apart more than once. In a particular embodiment, the reclosable coating material is a labile, coatable material which can be transformed into a flowable coating substance by processing methods involving heat application, which can be at least partly cured in place, and/or alternatively, it reverts or changes into a generally non-flowable material at room temperatures (e.g., about 80° F. or less), so that it remains affixed to a substrate at the original coating location. Also, in one non-limiting embodiment, the reclosable coating material also maintains low but sufficient bonding tack to keep the bag sealed at temperatures commonly experienced in refrigerated or frozen storage of some perishable foods, such as storage temperatures between about 32° F. to about 40° F. In one embodiment, the reclosable coating material is selected from the group consisting of ethylene vinyl acetate (EVA) copolymers, water-based acrylics, curable acrylics, and styrenic block copolymers. The reclosable coating material may be a transparent, translucent or a tinted coating material. The reclosable coating material may be sourced from commercial coatable pressure-sensitive adhesive products, such as EVA copolymer based hot melts available from Bostik Findley, Inc., or curable acrylic adhesive products. In a particular embodiment, curable acrylic adhesives are used, which in a procured state can be heated to a flowable condition and conveniently coated or deposited upon a packaging film in bands or stripes, and then are at least partly cured, e.g., via ultraviolet light irradiation or electron beam exposure, to fix the position of the coating. The acrylic can contain conventional adhesion promoters and/or photoinitiators for u.v. light irradiation, and so forth.

In another particular embodiment, the reclosable closure 117 comprises a self-supporting composite band material attached on the interior faces of the front and rear panels of the package. The composite band material may comprise a single-faced adhesive tape substrate which supports a reclosable coating, such as described above, on one side thereof which is opposite to the tacky side of the tape substrate. The tape may be a transparent, translucent or tinted discrete band material. The substrate tape material may be sourced from commercial single faced tape products, such as those available from Tesa and 3M.

In FIGS. 1-2, resealable band 117 is comprised of two resealable bands 117a and 117b. The resealable band 117 can be either one-piece or multi-piece construction, such as the illustrated two-piece construction. If a non-self-supporting bead or band of reclosable coating material is coated or otherwise deposited upon the packaging film, a single piece band is particularly convenient. However, if the resealable bands are a self-supporting composite tape type, then two discrete self-supporting pieces or bands are generally more convenient.

As indicated above, there is an additional non-reclosable peelable seal 118 provided below the resealable bands 117a and 117b that compose reclosable closure 117 that separate or isolate the resealable bands 117a and 117b from the product 120 contained in cavity 104 until peelable seal 118 is ruptured. The protective lower peelable seal 118 (i.e., 118a, 118b) is peelable to allow easy access to the product 120. The peelable seal 118 helps protect the resealable bands 117a and 117b of reclosable closure 117 from product contamination after packaging during shipment, storage, merchandising, etc., until the package is opened for the first time by the purchaser or other end user. Also, the peelable seal 118 aids in providing a hermetically-sealed package since the resealable bands 117a and 117b may extend into the side seals 111 and 112, affecting the seal quantity at those overlaps.

A hermetic peelable seal 118 is particularly desirable. A hermetic peelable seal may be formed in any suitable manner. In general, the walls 102 and 103 of packaging film 101 may be formed of a polymeric film material which is heat sealable, such that the peelable seal 118 can be formed where desired in the polymeric film per se without need for extraneous bonding materials. For example, the packaging film may be formed of a polybutylene/polyethylene blend which allows walls 102 and 103 to be heat sealed together at contacting portion that have a peel strength less than the cohesive strength of the adjoining unbonded portions of the walls. In this manner, the package 100 can be opened along peel seal 118 without tearing adjoining unbonded wall portions of the package. The strength of the peelable seal 118 is such that it can be readily opened by application of manual outward force to the package by the consumer, but is not susceptible to accidental opening due to normal stresses associated with product containment during the form/fill/seal (FFS) operation, and subsequent shipping, handling, and display. For instance, the peelable seal preferably has an opening force of from about 1.5 to about 6.0 lbs., and more preferably from about 2.5 to about 3.5 lbs. The peelable seal 118 may be formed with heat sealing techniques to provide a substantially impermeable seal to air, as well as to liquids which may be present in the pouch. Accordingly, the location of the peelable seal interiorly of the reclosable closure 117 prevents any contents of the pouch cavity 104 from leaking into the reclosable closure 117 before the filled package is purchased and initially used.

The various fusion seals 111, 112, and 113 of package 100 can be formed in conventional manners applicable to plastic bag manufacture, such as by ultrasonic sealing, heat sealing, etc. For instance, conventional heat sealing bars may be used for this purpose. The line of weakness 114 may be formed in conventional manners used to form such structural features in flexible packaging films, such as by laser scoring, using a die line, intermittent perforation, mechanical scoring, partial slitting through a packaging film laminate construction, etc. The notch 115 may be formed when the individual package is cut from a chain of bags. Alternatively, it may be formed by a conventional notched perforation wheel on the line at a perforation station or alternatively by a reciprocating perforating blade conventionally used for this purpose. The line of weakness 114 is generally horizontally aligned with a notch 115 formed at one side (or optionally both sides) of the reclosable package 100. The notch 115 is use to assist initiation of a tear and the tear line directs the tear as it propagates along the line of weakness 114, until the top edge portion 116 of the package 100 is separated from the remainder of the package 100 located below the line of weakness 114. In this manner, top fusion seal 113 represents a removable non-reclosable closure.

The film substrate 101 is a polymeric sheet material or film which may be formed of various plastic polymers, copolymers, co-extrusions and/or laminations. The polymeric sheet material or film 101 may be comprised, e.g., of monolayer or multi-layer combinations of: polyolefin such as polyethylene (high, medium, low, linear low, and/or ultra low density polymers including metallocene), polypropylene (oriented and/or biaxially oriented); polybutylene; ethylene vinyl acetate (EVA); polyamides (oriented and/or biaxially oriented) such as nylon; polyethylene terephthalate (oriented and/or biaxially oriented); polyvinyl chloride; ethylene vinyl alcohol (EVOH); polyvinylidene chloride (PVDC); polyvinyl alcohol (PVOH); polystyrene; or combinations thereof.

As previously noted, in a particular embodiment the film 101 may comprise a polyethylene/polybutylene blend in which peelable seals 118 may be formed, and also non-peelable edge and/or end heat seals (e.g. 111, 112, 113). Non-peelable edge and end seals may be formed by applying greater thermal energy to the heat fusion bond sites formed in the packaging film.

The film substrate 101 also may comprise flexible polymeric film materials filled with micro- or nano-sized inorganic materials or minerals, such as clay, calcium carbonate, montmorillonite, dolmite, talc, mica, and so forth. The film substrate 101 also may comprise flexible metallized film or a ceramic-coated film, e.g., a flexible film bearing a thin film of silicon oxide or aluminum oxide, and so forth, deposited on it. The film substrate 101 also may comprise flexible metal foil.

Film 101 desirably has air barrier properties to aid in providing hermeticity for the package, and is conducive to being heat sealed to adjoining contacted portions of folded or separate packaging film or layers. It also may incorporate non-plastic components such as foil, metallization, and/or paper, to the extent the barrier and heat sealing properties are sufficiently maintained. For purposes of example, a suitable film for cheese shreds may comprise a linear low-density polyethylene inner layer in combination with a polyester or nylon outer layer, and a middle adhesive layer of polyethylene. A nylon outer layer is particularly useful in connection with cheeses, where a degree of CO₂ gas permeability is desirable in the packaging.

To facilitate support of the package 100 on a display hanger, a hole 122 optionally may be provided in an upper end portion 116 of the package 100 at a location above the reclosable closure 117 and below the notched line of weakness 109. Hole 122 also could be provided below line of weakness 114 in portion 119, or below band 117.

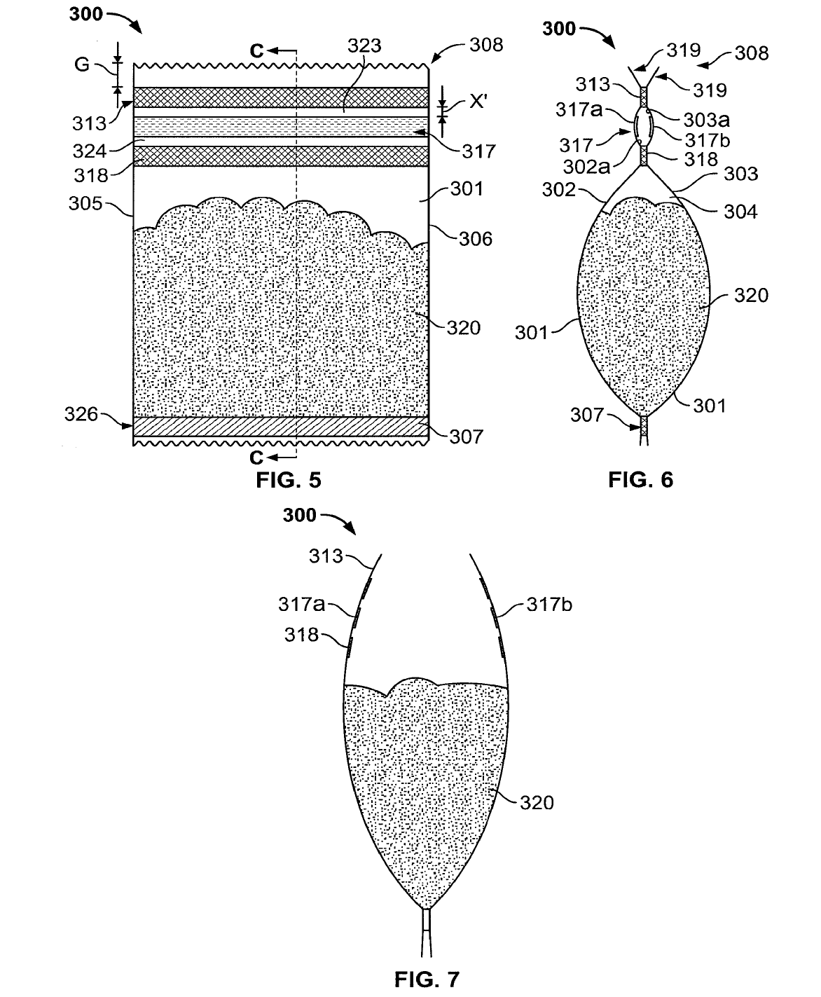

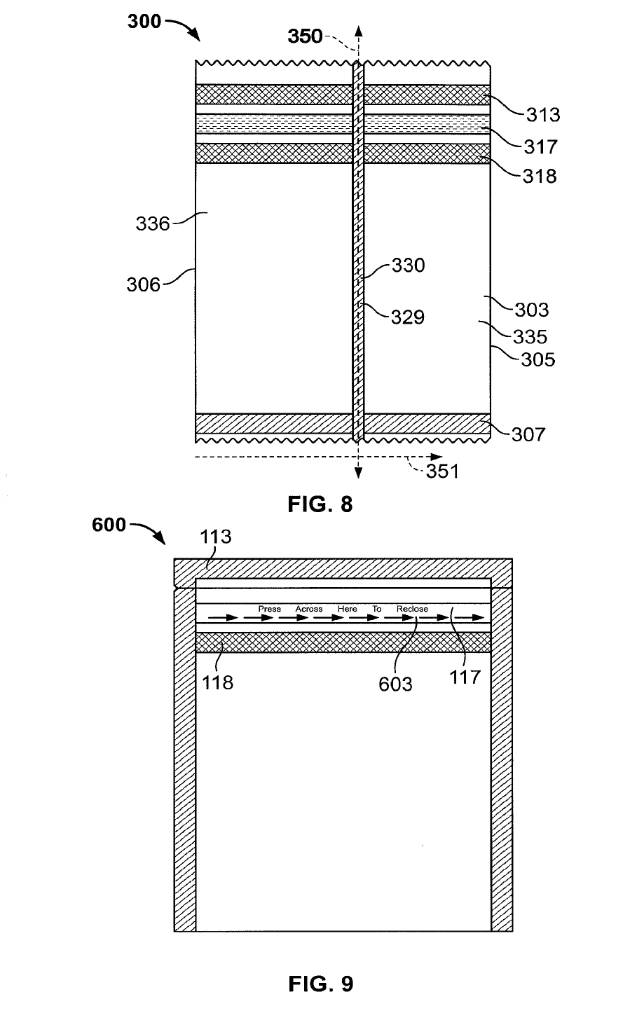

Referring to FIGS. 5-8, a pillow-shaped reclosable package 300 is illustrated in accordance with another embodiment of the invention. In this illustration, the package 300 is formed from a flexible sheet 301 of polymeric material which has opposed front and rear panels 302 and 303 joined together to define a cavity 304. In this illustration food 320 is contained within cavity 304. For example, the package 300 may be constructed by folding a polymeric sheet 301 at the opposite side portions 305 and 306 sufficient to provide flaps 335 and 336 extending in a machine direction 350 of the package 300 arranged to include a machine direction overlap portion 329 at which a fusion seal 330 is formed to provide a lengthwise fin seal, and a bottom portion 326 of package 300 is fusion sealed in a cross-machine direction 351, oriented generally perpendicular to machine direction 350, at non-peelable bottom fusion seal 307.

At an upper end portion 308 of package 300 opposite bottom portion 326, two generally parallel, spaced-apart peelable seals 313 and 318 are provided having a construction similar to feature 118 described above. Peelable seals 313 and 318 can be provided by bonding the packaging film 301 with less thermal energy than used to form non-peelable seal 307 at the bottom of the bag 300. An openable reclosable closure 317 is provided between peelable seals 313 and 318. Reclosable closure 317 comprises resealable bands 317a and 317b. Film portion 319 extends above the upper peelable seal 313 to provide the user some loose material to grip for separating the bag panels. The dimension of film extension 319 at the top of the package is indicated by “G” (FIG. 5). There are small gap spaces 323 and 324 provided between the peelable seals 313 and 318 and the intervening reclosable closure 317, which have a dimension “X”'. Similar to reclosable closure 117 described above in connection with FIGS. 1-4, the reclosable closure 317 comprises reclosable coating bands 317a and 317b formed on the opposing inner faces 302a and 303a of walls 302 and 303. The reclosable closure 317 and its constituent resealable coating bands 317a and 317b may comprise similar materials and implementations as the above-described reclosable closure feature 117. The cross-sectional view of FIG. 6 shows the resealable bands 317a and 317b as unbonded prior to the first opening of the cavity 304 of package 300. Similar also to feature 117 of FIGS. 1-4, the reclosable closure 317 can be provided as bands which are initially bonded or unbonded. Similar to feature 118 described above in connection with FIGS. 1-4, the lower peelable seal 318 provides protection to the reclosable closure 317 to avoid contamination of the food contents 320 of the package 300. FIG. 7 shows a fully opened configuration of package 300 which can be resealed at reclosable closure 317.

As illustrated in FIGS. 1-8, fill-through-the-top reclosable packages are provided with a re-openable seal for reclosing the bag upon a partial discharge of the contents thereof. These above illustrations show the relative positions of the resealable bands and non-reclosable package seals and opening features providing easy opening and reclosing of the package during use. Food materials which can be stored in these resealable packages are not particularly limited. For example, cheese shreds, ground coffee, vegetables, snack foods, confections, etc., may be contained in packages of embodiments herein. Many food products quickly deteriorate in the presence of air. Package configurations of embodiments herein also permit a consumer to easily expel air from the cavity 104 by merely applying manual pressure over the cavity region towards the package opening immediately prior to reclosing package 100 with reclosable closure 117. After any of the aforementioned bag designs 100 and 300 of FIGS. 1-8 are opened by a consumer to remove a food portion or other item stored therein, the consumer merely needs to press across the bag or pouch at a point where the resealable bands 117a and 117b (or 317a and 317b) are located to reclose and reseal the pouch for further storage of the remaining contents. Also, although the illustrations of FIGS. 1-8 describe folded single-piece package constructions, it will be appreciated that the embodiments of the present invention are also applicable to packages constructed of two-piece superposed film constructions.

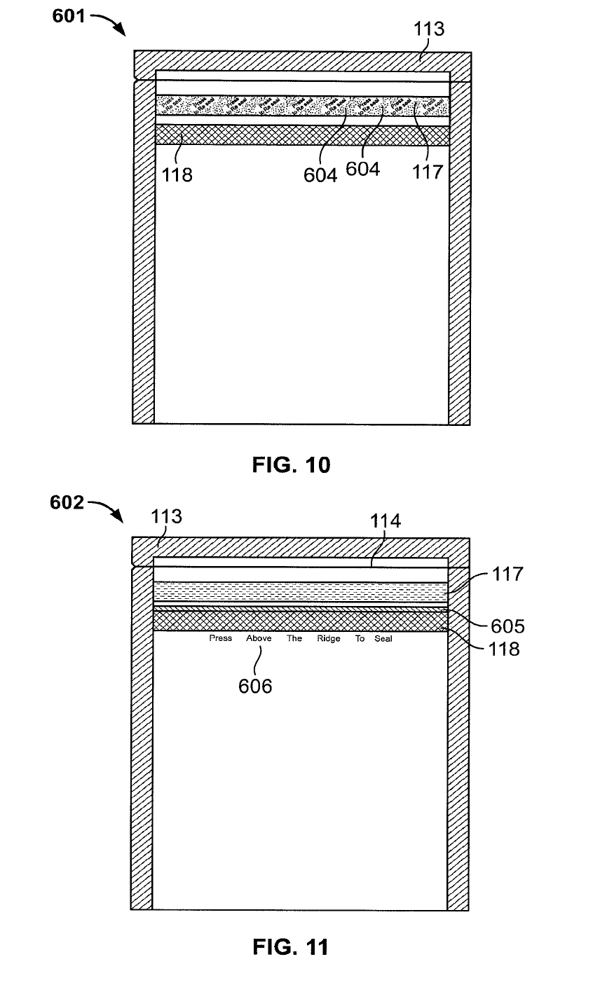

Referring to FIGS. 9-11, in further optional embodiments, various types of indicators 603-606 may be added to a reclosable bag or pouch (600-602) to assist the consumer in locating the resealable bands 117 for efficiently locating them and using then to reclose and reseal the package. Pressing the pouches 600-602 in the proper location is imperative to effect proper resealing. The indicator provided on the package can be graphical (visual) and/or textural (tactile) in nature. Non-limiting examples of such graphical indicators 603 and 604 are shown in FIGS. 9 and 10. These graphical indicators, as illustrated, may comprise written text and/or graphical symbols. Referring to FIG. 11, a textural indicator 605 may be used, which may be, e.g., a protuberance or ridge structure formed by mechanical embossing on the packaging film 101 immediately adjacent where the reclosable closure 117 is located. Another approach may be the forming of a ridge in the film during the sealing operation. This ridge 605 also could be produced by sealing tools used to create the lower peelable seal 118. Referring still to FIG. 11, graphics 606, such as written text, also can be provided to further help instruct the user to locate and press above the ridge 605 to reseal the bag 602. Although bags 600-602 otherwise are illustrated as being similar to above-discussed reclosable flexible package 100, it will be appreciated that these further embodiments are also applicable to configurations of reclosable flexible package 300 configurations.

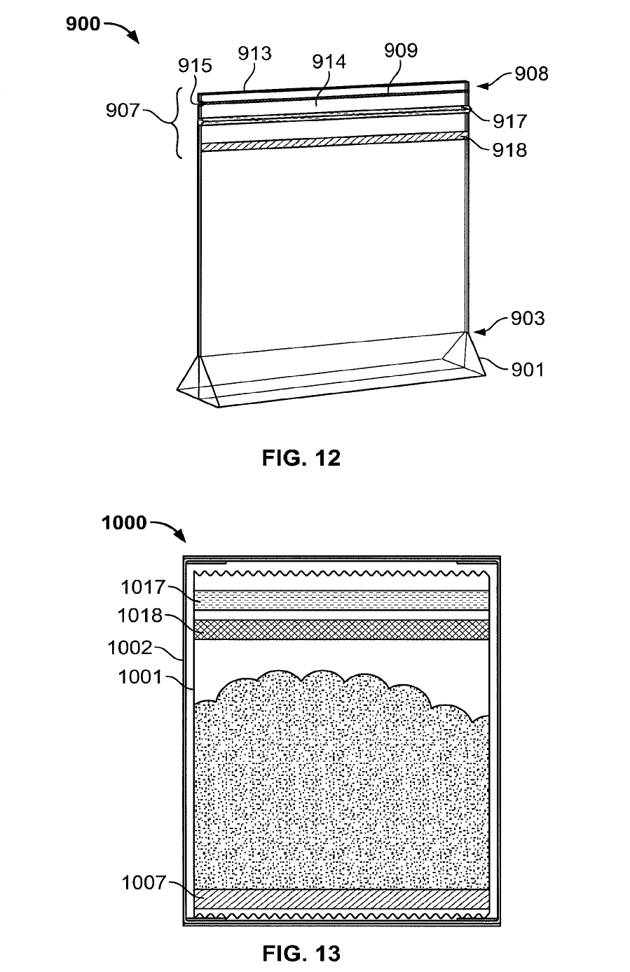

Referring to FIG. 12, in another embodiment a flexible reclosable stand-up bag 900 is provided having a gusset portion 901 near the bottom 903 of the bag 900. At the opposite upper end 908 of the bag 900, a sealing arrangement 907 is provided that is generally similar to that of the package of FIG. 1. In this non-limiting embodiment, sealing arrangement 907 includes a notched line of weakness 909 provided immediately below and generally parallel to the top fusion seal 913, which in this illustration includes a rupturable line of weakness 914 and associated side tear notch 915. Openable reclosable closure 917 is provided below and generally parallel to fusion seal 913 and the notched line of weakness 909. A non-reclosable peelable seal 918 is provided below and generally parallel to the reclosable closure 917 at a lower location in the upper end 908 of package 900. The notched line of weakness, openable reclosable closure and non-reclosable peelable seal can have respective constructions and features as described above. The gusset portion 901 may be formed using any conventional technique used for forming such constructions in free end portions of two superposed layers of flexible plastic.

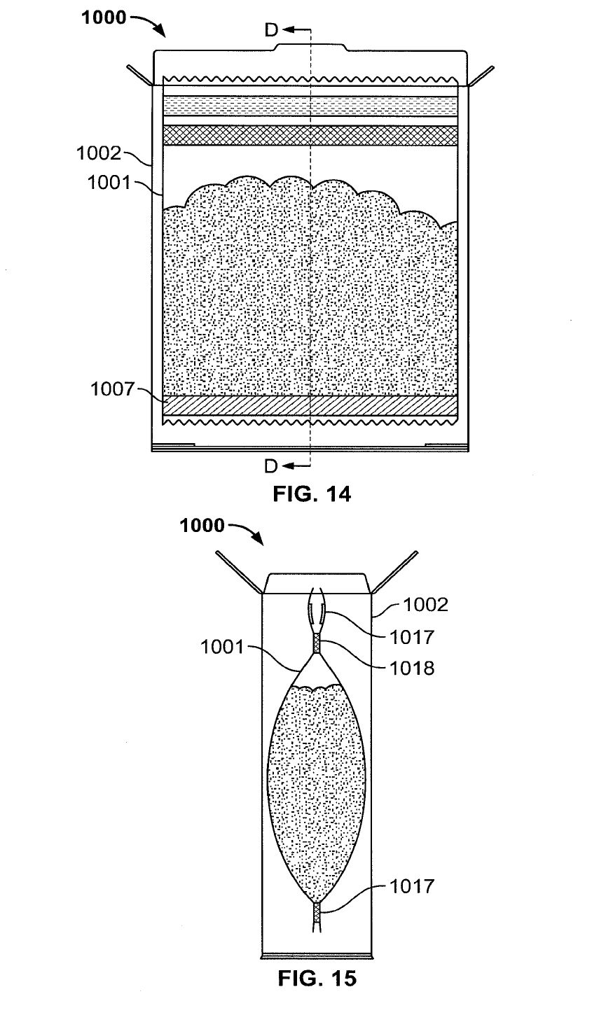

Referring to FIGS. 13-15, in another embodiment a bag-in-box package 1000 is provided having a bag 1001 having a construction similar to above-described bag 300 except that a peelable seal 1018 is provided below reclosable seal 1017, but not above it. The outer, sealable packaging box 1002 effectively provides a non-reclosable seal means used in lieu of an upper non-reclosable seal formed in the pouch itself that must be initially opened before the reclosable seal 1017 can be accessed for the first time. The box packaging also lends itself to merchandising and handling. Reclosable seal 1017 is similar to above-described seal 317. A lower heat sealed portion 1007 of bag 1001 is a non-peelable seal similar to previously described seal 318.

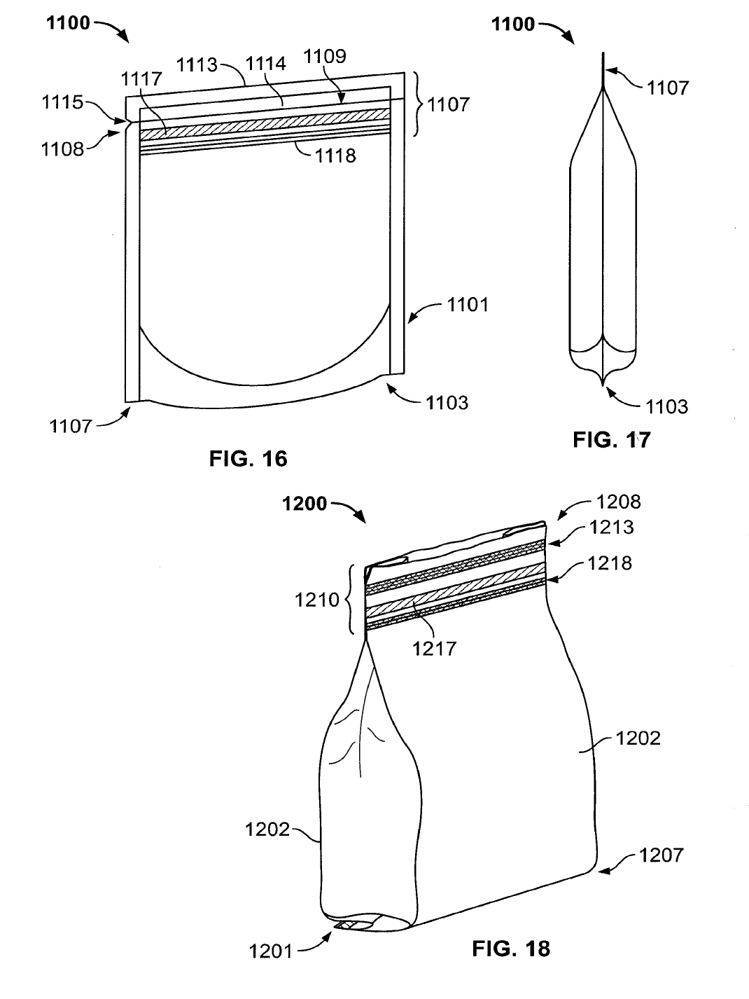

The reclosable package sealing arrangements of the present invention also can be applied to other styles of packages. Referring to FIGS. 16-17, for instance, in another embodiment a flexible reclosable Doy-style stand-up pouch 1100 is provided having a cupped bottom portion 1101 having a bottom seal configuration 1103 at the lower pouch end 1107 adapted to allow the pouch to stand up. At the opposite upper end 1108 of the pouch 1100, a sealing arrangement 1107 is provided that is generally similar to that of the package of FIG. 1, including a score line 1109, provided immediately below and generally parallel to the top fusion seal 1113. The score line 1109 provides a rupturable line of weakness 1114 and associated side tear notch 1115. Openable reclosable closure 1117 is provided below and generally parallel to fusion seal 1113 and the score line 1109. A non-reclosable peelable seal 1118 is provided below and generally parallel to the reclosable closure 1117 at a lower location in the upper end 1108 of package 1100.

Referring to FIG. 18, in yet another embodiment a flexible flat bottom bag 1200 with a tucked bottom seal portion 1201 is provided. This embodiment is a variation of the pillow-shaped reclosable package such as illustrated in FIGS. 5-8. In this illustration, the flat bottom bag 1200 is formed from a flexible sheet of polymeric material 1202 defining a cavity. The bag 1200 has and upper end 1208 and lower end 1207. The sealing arrangement 1210 provided at the upper end 1208 is similar to that described above for the package 300 illustrated in FIGS. 5-8, and includes a resealable coating 1217, which can be similar to above-described reclosable closure 317, provided between upper and lower peelable seals 1213 and 1218, which may similar to above-described peelable seals 313 and 318. At the opposite lower end 1207 of the bag 1200, loose ends of the polymeric sheet material 1202 are joined as a tucked bottom seal to provide a flat bottom structure.

In non-limiting form, fill and seal (“FFS”) operations applicable to manufacturing resealable packages according to the illustration of FIG. 1, the package 100 is manufactured with a horizontal or vertical fill technique. In one exemplary horizontal FFS operation, a bag chain, precoated with transverse bands of reclosable coating 117 intermittently along its length, has side fusion seals 111 and 112 formed in a given folded pouch. The intermediate bag with sealed sides is cut from the bag chain, then filled with product at its open end, and the filled pouch cavity is gas flushed (e.g. N₂ or CO₂). Peelable seal 118 is formed in the upper open mouth portion of the bag, followed by formation of non-peelable top edge seal 113 to seal the contents within the pouch. Reclosable coating 117 and peelable seal 118 can be formed in manners such as previously described herein. Fusion seal 113, for example, is formed at the horizontal top edge of the package, such as by using a conventional horizontally-oriented sealing bar, along with the notched line of weakness 109, to provide a hermetically-sealed, resealable filled package. The process provides an impermeable marginal sealed area on each side of the filled pouch. Where a punched hole 122 is desired, a punch apparatus may be provided at a convenient location on the production line.

In an alternative FFS operation for making packages such as illustrated in FIG. 5, a right-side up or an inverted vertical fill operation may be used to form filled package 300. In a right-side up vertical fill procedure, a bag chain is provided with reclosable coating 317 at intermittent transverse locations. A bottom seal 307 is initially formed for a given bag. The intermediate bag is then filled and flushed. Then, peelable seal 318 and non-peelable seal 313 are formed, in that sequence, and the sealed filled bag is cut from the bag chain. In an inverted bag FFS operation, filled package 300 can be assembled generally by reversing the sequence of steps, such that the mouth-end seals 313, 317 and 318 are formed first, following by filling the bag, and finally by forming bottom seal 307.

The resealable flexible packages of embodiments of the invention offer many advantages over traditional package resealing arrangements, and particularly zippers. Manufacturing of the flexible packages of the preferred embodiments is streamlined because resealable bands used to form the reclosable closure (e.g., above-described features 117 and 317) are easier and less costly to apply and use than an integral zipper. Also, a conventional film converter may be used to coat the bands directly onto the film where needed and deliver all the materials on a ready-to-use single roll. In that case no additional equipment is necessary to make the packages of embodiments herein. This enables the manufacture of reclosable packages according to embodiments herein on a variety of form, fill, and seal machines. Since the reseal bands used to form the reclosable closure are applicable as a thin coating, the resulting low material usage provides a cost savings relative to zipper packaging, especially higher cost slider zipper packaging. Consumers have added ease and comfort using the packaging of embodiments herein due to the easy and reliable closing of the reseal band arrangement used in packages of embodiments herein versus the often difficult and inconsistent press-to-close zippers. Also, tamper-resistance is provided for the reclosable closure and package contents by provision of hermetic manually-openable, non-reclosable seals at both sides of the reclosable closure, which serve to better isolate it during manufacture, shipping, storage, handling and display, etc., until purchased and used by a consumer.

Methods of forming and using the reclosable package are also provided. Namely, if the heat seal (113, 313) is ruptured in a displayed package, it alerts that possible access or exposure of the reclosable coating seal (117, 317) has occurred prior to purchase. If the peelable seal (118, 318) is ruptured, it alerts that the package contents may have been exposed prior to purchase. The resealable seal and food contents thus can be better preserved in as-packaged conditions until sold and used.

1-23. (canceled)

24. A reclosable flexible package having a reclosable closure comprising:
a reclosable coating securement in combination with non-reclosable closures located above and below the reclosable closure in the package; and
a line of weakness extending across the package below the upper non-reclosable closure and above the reclosable coating securement to enable removal of an upper end portion of the package including the upper non-reclosable closure, the package having a hole through the removable upper end portion adapted for hanging the package from a display hanger.

25. The package of claim 24, wherein the reclosable closure comprises pressure-sensitive adhesive on interior faces of the front and rear panels.

26. The package of claim 25, wherein the reclosable closure comprises at least one band of reclosable coating material adapted to releasably attach opposing interior faces of front and rear panels of the package.

27. The package of claim 25, wherein the reclosable closure comprises substantially continuous bands of reclosable coating material oppositely aligned on interior faces of front and rear panels of the package, wherein the bands are adapted to be pressed into mutual adhering contact and manually pulled apart more than once.

28. A reclosable flexible package, comprising:
opposed front and rear panels joined together to define a cavity enclosed by opposite side portions and a bottom portion of the package;
a removable non-reclosable closure, located at an upper end portion of the package opposite the bottom portion and extending between opposite side portions of the package, adapted to define a package mouth when removed;
an openable reclosable closure comprising a reclosable coating extending between the opposite side portions of the package at a location below the removable non-reclosable closure, adapted to be manually pulled open and reclosed for selectively opening and closing said mouth after said removable non-reclosable closure has been removed;
an openable non-reclosable closure extending between the opposite side portions of the package at a location below the reclosable closure; and
a hole through the removable non-reclosable closure by means of which the package can be supported on a display hanger.

29. The package of claim 28, wherein the reclosable closure comprises reclosable coating provided on interior faces of both the front and rear panels.

30. The package of claim 28, wherein the reclosable closure comprises substantially continuous bands of reclosable coating oppositely aligned on interior faces of the front and rear panels, wherein the bands are adapted to be pressed into mutual adhering contact and manually pulled apart more than once.

31. The package of claim 28, wherein the reclosable closure comprises a discrete self-supporting composite tape material attached on interior faces of the front and rear panels, wherein the self-supporting composite tape material comprises a single-faced adhesive tape supporting a reclosable coating on one side thereof.

32. The package of claim 28, wherein the removable non-reclosable closure extends between the opposite side portions of the package forming an air seal between the exterior of the package and the reclosable closure.

33. The package of claim 28, further comprising a rupturable line of weakness between the removable non-reclosable closure and the reclosable closure, adapted, upon complete rupture, to allow removal of the removable non-reclosable closure.

34. The package of claim 33, wherein the line of weakness intersects a notch provided on at least one side edge of the package.

35. The package of claim 28, wherein the package comprises a construction wherein a folded polymeric sheet provides the front and rear wall panels which are joined at opposite side portions thereof and folded at a bottom portion thereof.

36. The package of claim 28, wherein package comprises a construction wherein a polymeric plastic sheet is folded at the opposite side portions sufficient to provide a machine direction overlap portion which is sealed and a bottom portion is sealed in a cross-machine direction.

37. A method of forming a reclosable flexible package, comprising the steps of:
joining opposed front and rear panels together to define a cavity enclosed by opposite side portions and a bottom portion of the package, and an open upper end communicating with the cavity;
forming, in the open upper end, an openable non-reclosable closure extending between the opposite side portions of the package;
forming, at a location above the openable non-reclosable closure in the open upper end, an openable reclosable closure comprising a reclosable coating, extending between the opposite side portions of the package, adapted to be manually pulled open and reclosed for selectively opening and closing the upper end;
forming a removable non-reclosable closure located above the openable reclosable closure in the upper end and extending between opposite side portions of the package, adapted to define a package mouth in the upper end when removed;
forming a line of weakness across the package between the removable non-reclosable closure and the openable reclosable closure; and
forming a hole through the removable non-reclosable closure, adapted to enable the package to be supported from a display hook.

38. The method of claim 37, wherein the step of forming the reclosable closure comprises applying a reclosable coating on interior faces of the front and rear panels.

39. The method of claim 38, wherein the step of applying a recloseable coating comprises depositing substantially continuous bands of reclosable coating in aligned opposition on interior faces of the front and rear panels, wherein the applied reclosable coating bands are adapted to be pressed into mutual adhering contact and manually pulled apart more than once.

40. The method of claim 37, wherein the step of forming the reclosable closure comprises attaching discrete self-supporting composite tape material on interior faces of the front and rear panels, wherein the self-supporting composite tape material comprises a single-faced adhesive tape supporting a reclosable coating on one side thereof.

41. A reclosable flexible package comprising:
a flexible sheet of material folded at opposite side portions sufficient to provide a machine direction overlap portion which is sealed, the folded sheet defining opposed front and rear panels which are joined together at a lower end of the package in a tucked bottom seal in a cross-machine direction, the package having a reclosable closure at the upper end comprising a reclosable coating securement means in combination with non-reclosable closures located above and below the reclosable closure in the package.

42. The package of claim 41, wherein the reclosable closure comprises pressure-sensitive adhesive on interior faces of the front and rear panels.

43. The package of claim 42, wherein the reclosable closure comprises at least one band of reclosable coating material adapted to releasably attach opposing interior faces of front and rear panels of the package.

44. The package of claim 42, wherein the reclosable closure comprises substantially continuous bands of reclosable coating material oppositely aligned on interior faces of front and rear panels of the package, wherein the bands are adapted to be pressed into mutual adhering contact and manually pulled apart more than once.

45. A reclosable flexible package, comprising:
a flexible sheet of material folded at the opposite side portions sufficient to provide a machine direction overlap portion which is sealed, the folded sheet forming opposed front and rear panels which are joined together at a lower end of the package by a tucked bottom seal in a cross-machine direction to define a cavity enclosed by opposite side portions and a bottom portion of the package;
an openable and removable non-reclosable closure, located at an upper end portion of the package opposite the bottom portion and extending between opposite side portions of the package, adapted to define a package mouth when opened or removed;
an openable reclosable closure comprising a reclosable coating, extending between the opposite side portions of the package at a location below the openable and removable non-reclosable closure, adapted to be manually pulled open and reclosed for selectively opening and closing said mouth after said openable and removable non-reclosable closure has been opened or removed; and
an openable non-reclosable closure extending between the opposite side portions of the package at a location below the reclosable closure.

46. The package of claim 45, wherein the reclosable closure comprises reclosable coating provided on interior faces of both the front and rear panels.

47. The package of claim 45, wherein the reclosable closure comprises substantially continuous bands of reclosable coating oppositely aligned on interior faces of the front and rear panels, wherein the bands are adapted to be pressed into mutual adhering contact and manually pulled apart more than once.

48. The package of claim 45, wherein the reclosable closure comprises a discrete self-supporting composite tape material attached on interior faces of the front and rear panels, wherein the self-supporting composite tape material comprises a single-faced adhesive tape supporting a reclosable coating on one side thereof.

49. The package of claim 45, wherein the openable and removable non-reclosable closure extends between the opposite side portions of the package forming an air seal between the exterior of the package and the reclosable closure.

50. The package of claim 45, further comprising a rupturable line of weakness between the openable and removable non-reclosable closure and the reclosable closure, adapted, upon complete rupture, to allow removal of the openable and removable non-reclosable closure.

51. The package of claim 50, wherein the line of weakness intersects a notch provided on at least one side edge of the package.

52. A method of forming a reclosable flexible package, comprising the steps of:
folding a sheet of flexible material at opposite side portions sufficient to provide a machine direction overlap portion and sealing the overlap portion to form opposed front and rear panels;
joining the front and rear panels together at a lower end of the package in a tucked bottom seal so that the sheet defines a cavity enclosed by opposite side portions and a bottom portion of the package, and an open upper end communicating with the cavity;
forming, in the open upper end, an openable non-reclosable closure extending between the opposite side portions of the package;
forming, at a location above the openable non-reclosable closure in the open upper end, an openable reclosable closure comprising a reclosable coating, extending between the opposite side portions of the package, adapted to be manually pulled open and reclosed for selectively opening and closing the upper end; and
forming an openable and removable non-reclosable closure, located above the openable reclosable closure in the upper end and extending between opposite side portions of the package, adapted to define a package mouth in the upper end when opened or removed.

53. The method of claim 52, wherein the step of forming the reclosable closure comprises applying a reclosable coating on interior faces of the front and rear panels.

54. The method of claim 53, wherein the step of applying a recloseable coating comprises depositing substantially continuous bands of reclosable coating in aligned opposition on interior faces of the front and rear panels, wherein the applied reclosable coating bands are adapted to be pressed into mutual adhering contact and manually pulled apart more than once.

55. The method of claim 52, wherein the step of forming the reclosable closure comprises attaching discrete self-supporting composite tape material on interior faces of the front and rear panels, wherein the self-supporting composite tape material comprises a single-faced adhesive tape supporting a reclosable coating on one side thereof.
